(19) United States
(12) Patent Application Publication
(10) Pub. No.: US 2010/0091403 A1
(43) Pub. Date: Apr. 15, 2010

(54) DATA STORAGE DEVICE WITH MAXIMUM CAPACITY INCREASABLE THROUGH CONSUMPTION OF ADVERTISEMENT MATERIAL

(75) Inventors: Angel Andres Matson, Minnetonka, MN (US); Fumin Zhang, Eden Prairie, MN (US); David Scott Seekins, Allison Park, PA (US)

Correspondence Address: SEAGATE TECHNOLOGY LLC;C/O WESTMAN, CHAMPLIN & KELLY, P.A., SUITE 1400, 900 SECOND AVENUE SOUTH, MINNEAPOLIS, MN, 55402-3244, US

(73) Assignee: Seagate Technology LLC, Scotts Valley, CA (US)

(21) Appl. No.: 12/250,138

(22) Filed: Oct. 13, 2008

(51) Int. Cl. G11B 23/03; G06Q 30/00

(52) U.S. Cl. 360/133; 705/14.4

(57) ABSTRACT

A data storage device is disclosed. In one embodiment, the data storage device has a maximum storage capacity and is initially limited to providing access to a limited amount of data storage capacity that is less than the maximum data storage capacity. The size of the limited amount of data storage capacity is variable based on an indication of how much of a collection of advertising material has been viewed. In one embodiment, a host system manages a transfer of all or a portion of the collection of advertising material to a storage location on the data storage device. In one embodiment, the same host system manages adjustments to the size of the limited amount of data storage capacity based on how much of the collection of advertising materials has been consumed.

### BACKGROUND

It goes without saying that a typical purchaser of computer-implemented data storage equipment will search for and purchase equipment that meets their current needs in terms of storage capacity. In fact, most purchasers will be forward thinking and choose equipment that exceeds their current storage capacity needs. Under the circumstances, the purchase price will typically include compensation for capacity that is not currently needed.

In this market environment, a vendor of computer equipment might choose to offer data storage equipment in accordance with a capacity on demand (COD) scheme. For example, a potential purchaser of data storage equipment may be given the option of obtaining significantly more storage capacity than currently needed. In accordance with the COD scheme, at least a portion of the extra capacity remains unavailable (e.g., hidden from the user or otherwise locked out) until the purchaser desires access to it. When needed, some or all of the extra capacity can be paid for and then activated so as to enable access and use for storage (or activated and then paid for, etc.). An example of why a vendor might be motivated to provide computer resources on a COD basis is that the vendor hopes that, when additional capacity is needed, the customer will not explore other equipment purchase options but will instead take advantage of the already provided extra capacity. This is but one example of a market incentive.

Options for compensating a vendor for a capacity extension in a COD scheme can be straightforward or more creative. It may be as simple as payment for activation. However, in an example of a more creative alternative, a customer might be given an option to purchase extended capacity on a 30-day trial basis after which the extended capacity is turned off. In one aspect of the present invention, compensation plans might not be limited to direct financial compensation from the customer to the COD vendor.

### SUMMARY

Embodiments of a data storage device are disclosed. In one embodiment, the data storage device has a maximum storage capacity and is initially limited to providing access to a limited amount of data storage capacity that is less than the maximum data storage capacity. The size of the limited amount of data storage capacity is variable based on an indication of how much of a collection of advertising material has been viewed. In one embodiment, a host system manages a transfer of all or a portion of the collection of advertising material to a storage location on the data storage device. In one embodiment, the same host system manages adjustments to the size of the limited amount of data storage capacity based on how much of the collection of advertising materials has been consumed.

### BRIEF DESCRIPTION OF THE DRAWINGS

FIG. 1 is a simplified schematic block diagram of a capacity on demand storage scheme.

FIG. 2 is a simplified schematic block diagram of a capacity on demand storage scheme.

FIG. 3 is a block flow diagram demonstrating a process for managing a data storage device.

FIG. 4 is a block schematic diagram of a network-implementation of a capacity on demand scheme based on advertisement consumption.

FIG. 5 is a simplified exploded view of a data storage device.

FIG. 6 is a generalized functional block diagram of the device of FIG. 5.

FIG. 7 is a simplified block diagram of a solid state data storage device.

### DETAILED DESCRIPTION

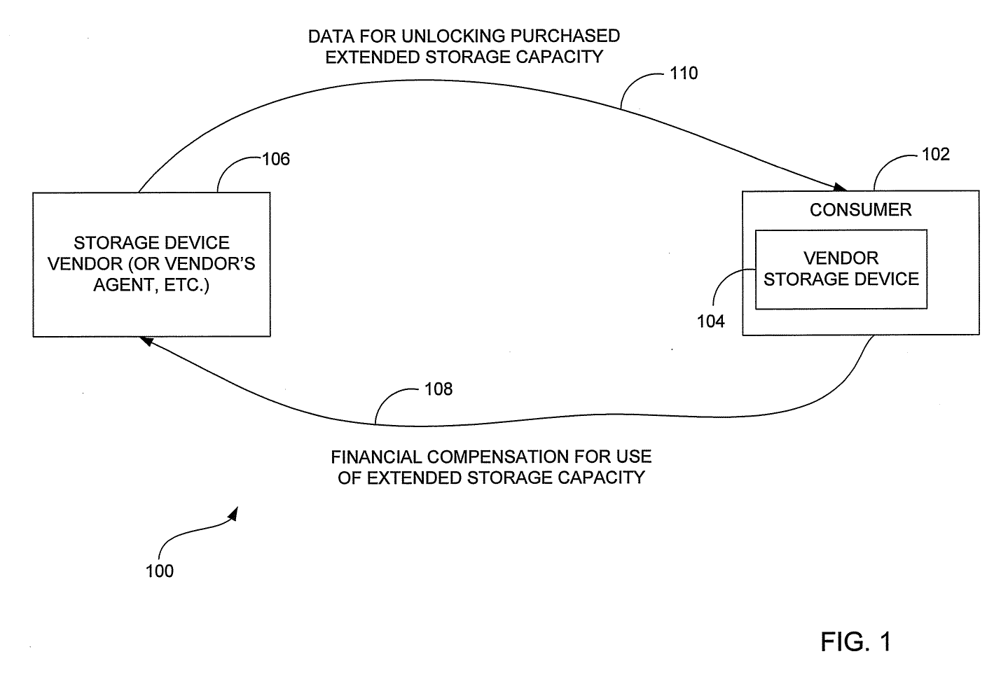

FIG. 1 is a simplified schematic block diagram of a capacity on demand (COD) storage scheme 100 involving direct financial compensation. In this case, a consumer 102 has purchased a data storage device 104 (or purchased a computing device that contains a data storage device, etc.). Device 104 is marketed and/or manufactured by a vendor 106. Assumedly, device 104 has a larger storage capacity than consumer 102 needs and/or wants. However, only a limited portion of the total storage capacity is initially made available to consumer 102. Assumedly, the limited portion is in line with the consumer's initial data storage needs and/or wants, and the price that consumer 102 paid for purchase of the device (or for purchase of the computing device, etc.) was based on that limited portion of the total storage capacity.

Accordingly, device 104 includes an extra storage capacity that is initially not made available to consumer 102. However, when needed, some or all of the extra capacity can be paid for and activated so as to enable access and use for storage (or activated and then paid for, etc.). As is indicated by arrow 108, consumer 102 provides vendor 106 (or the vendor's agent, related entity, business partner, etc.) with financial compensation in exchange for, as is indicated by arrow 110, information that enables access to some or all of the initially unavailable storage capacity.

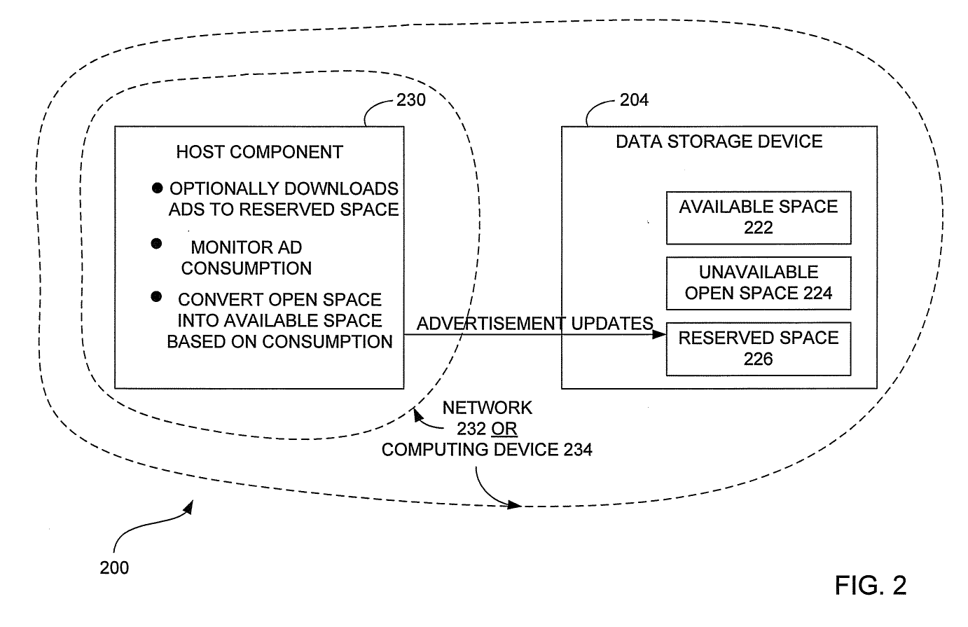

FIG. 2 is a simplified schematic block diagram of a capacity on demand (COD) storage scheme 200 involving compensation through the consumption of advertisement material. Included in the scheme is a data storage device 204 marketed and/or manufactured by a vendor. Device 204 includes at least three different “areas” where data can be store. A first area 222 is open and made accessible for data storage. A second area 224 is locked or otherwise made unavailable for data storage (e.g., hidden data sectors, etc.). A third area 226 is reserved for the storage of data in the nature of advertisement material. The consumer that owns and/or operates device 204 is initially limited to accessing only available area 222. It is again assumed (though it isn't necessarily true) that the price paid for the purchase of device 204 was based that limited portion of the total storage capacity.

Data storage space in unavailable area 224 (and, in theory, space in reserved area 226) can be reallocated to available space area 222 thereby increasing the total data storage capacity that is made available to the consumer and/or a user of device 204. A host component 230 is provided to manage this process of increasing the size of area 222. In one embodiment, as is indicated by dotted line 234, host component 230 is implemented as a software module that operates from the same computing device (e.g., the same personal computer, the same cell phone, the same laptop computer, etc.) to which data storage device 204 is connected so as to enable data storage and retrieval operations. In another embodiment, as is loosely identified by dotted circle 232, host component 230 is a software module that operates from a network-implemented computing device (e.g., a server) that is separate from, but in remote communication with, the computing device to which data storage device 204 is connected. Thus, without departing from the scope of the present invention, host component 230 can be configured to locally or remotely issue and execute commands so as to affect the configuration of data storage device 204.

In one embodiment, component 230 is configured to extend available space (i.e., by re-allocating some or all of spaces 224 and 226) based at least in part data confirming that advertising material has been consumed (e.g., viewed, listened to, etc.). Thus, extra storage capacity is “earned” by consuming advertising material. It should be noted that various schemes can be utilized to “unlock” the extra storage capacity (e.g., unlock all or portions of space 222 and/or 226). For example, in one embodiment, host component 230 is configured to monitor advertisement consumption and automatically issue space allocation commands when certain predetermined consumption benchmarks are reached. Optionally, component 230 can be configured to facilitate an automatic notification (e.g., an email) to notify a user when additional storage capacity has been earned. In one embodiment, a user is provided with a password or some other code that is input into a computing device and provided to host component 230 so as to demonstrate proper authorization to trigger arrangement for an extension of access. Or, in one embodiment, data for demonstrating proper authorization is remotely transmitted. The precise means for accomplishing activation is not critical to the present invention. All means for accomplishing should be considered within the scope of the present invention.

In one embodiment, some or all of the advertisements consumed by the consumer in order to “earn” an extended storage capacity are advertisements that promote products and/or services sponsored by the data storage device vendor. However, in another embodiment, the advertisements promote products and/or services of the vendor's partners, related entities, etc. One can imagine a scenario wherein a “third party” advertiser (e.g., an advertiser generally unaffiliated in a business sense with the vendor) pays financial compensation to the vendor in exchange for consumption of advertising material. These amounts paid by third party advertisers can be utilized to partially or completely offset payments that would otherwise be paid by the end consumer of the storage device product.

In one embodiment, the advertising material (e.g., HTML/images/video, etc.) that is consumed in order to “earn” extended storage capacity is stored in the reserved space area 226 of storage device 204 (e.g., contained on hidden sectors of a disc drive). In one embodiment, host component 230 facilitates a downloading (e.g., a streaming) of some or all of the advertisement content from the Internet (e.g., from a pre-configured server that operates as an ad content source). In another embodiment, some or all of the advertisement content is pre-installed before the storage device reaches the end consumer. For example, the device vendor or a related original equipment manufacturer can format the media with pre-canned advertisements.

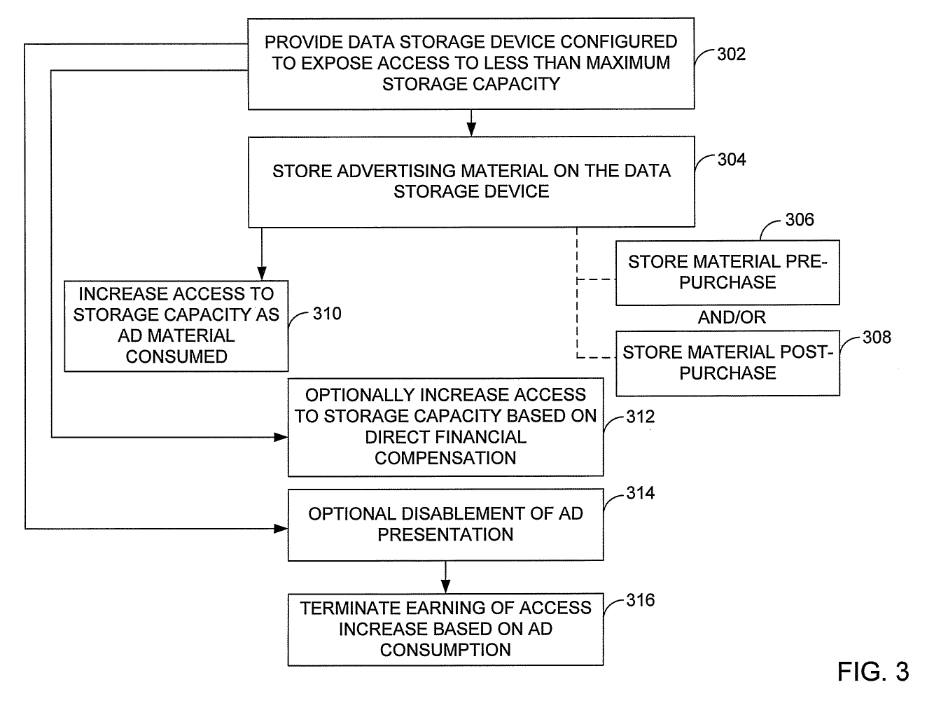

FIG. 3, in accordance with one aspect of the present invention, is a block flow diagram illustrating a process for configuring a data storage device. In accordance with block 302, a data storage device is configured to only expose access to a limited portion (e.g., half) of its available storage space. Thus, in theory, the purchasing consumer may be charged for only a corresponding portion of the potentially available storage space. In accordance with block 304, advertising material is, in block 306, installed before the purchaser received the device (e.g., installed by the device manufacturer) and/or, in block 308, after the purchaser received the device (e.g., downloaded from a dedicated content store). In accordance with block 310, as more of the advertisement material is consumed, more storage capacity is made available. In accordance with block 314, in one embodiment, at any time, the advertisement system can be selectively disabled (e.g., a user chooses to disable the presentation of advertisement material). In accordance with block 316, at this point, additional storage space is not made available. In accordance with block 312, in one embodiment, the some or all of the additional storage space can be purchased on a financial basis, a transaction that, in one embodiment, is facilitated by host component 230. In one embodiment, once all storage has been “earned” through advertisement consumption and/or financial purchases, the displaying of advertisements halted.

As was alluded to in the description of FIG. 2, data storage device 204 and host component 230 can be implemented on the same computing device such that the described storage capacity on demand scheme based on advertisement consumption can be facilitated without any assistance from a system component implemented on the Internet or some other network (assuming device 204 is pre-configured with ad material in area 226, then there may be no need to download advertisement updates). Accordingly, in one embodiment, the scheme is operational even if there is no connection to the Internet or any other network. The solution is operation “out of the box,” so to speak.

Alternatively, as was also alluded to in the context of FIG. 2, some or all of the system components can be remotely implemented. To emphasize that point, an example will now be given. Those skilled in the art will appreciate that the following example is but one of many different ways to distribute components of the system across a network. It will also be appreciated that, without departing from the scope of the present invention, components and functions of the scheme can be moved to either side of the network.

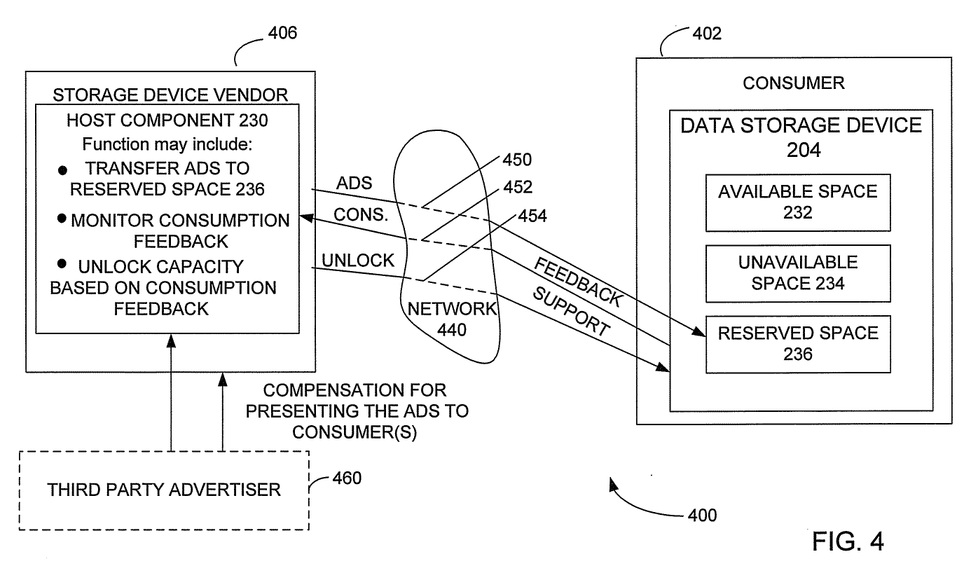

FIG. 4 is a block schematic diagram of one example network implementation of a capacity on demand scheme based on advertisement consumption. The example configuration is identified in the figure as system 400. System 400 is similar to scheme 200 in that it also includes data storage device 204 and host component 230. For illustratively purposes only, device 204 is shown in the context of a consumer 402 and component 230 is shown in the context of a storage device vendor 406. These associations are not mandatory and are intended only to demonstrate a scenario in which, in the end, the consumer has ultimate control of device 204 and the vendor is has ultimate control of host component 230.

Communication between device 204 and host component 230 is conducted across a network 440. Component 230 and device 204 are illustratively implemented in, on or in association with any computing device such as, but not limited to, a hand-held device, a server, a router, a network PC, or a peer device. Network 440 can be any network such as, but not limited to, the Internet, a cellular phone network, any local area network (LAN), any wide area network, or any combination thereof. Communication between device 204 and component 230 can be wireless, wired, or a combination of wired and wireless communication.

As is indicated by arrow 450, component 230 remotely transfers ads to device 204. These ads are illustratively stored in reserved space 236. As is indicated by arrow 452, information related to the consumption of the ad material in space 236 is remotely communicated to host component 230. As is indicated by arrow 454, based on the consumption feedback, host component 230 provides information to enable an expansion of available space 232 (e.g., reallocation of space from space 234 and/or 236 to space 232). In this manner, consumer 402 “earns” additional available space by consuming advertising material.

FIG. 4 shows an optional third party advertiser 460 that provides compensation (e.g., financial compensation) to vendor 406 for the presentation of ad material to consumer 402 and other consumers. In this manner, advertiser 460 illustratively is able to subsidize the price that consumer 402 pays for data storage device 204 (or for a computing device that contains device 204, etc.). For example, vendor 406 illustratively receives all or part of the purchase compensation for device 204 from third party advertiser 460.

Again, FIG. 4 is but one example of a distributed implementation. It is certain within the scope of the present invention to implement any function remotely and/or locally.

Up to this point, embodiments of the present invention have been generally described in the context of “a data storage device.” Those skilled in the art will appreciate that this could mean any of a variety of different data storage devices. In one embodiment, the device is a hard disc drive that reads from or writes to non-removable, nonvolatile magnetic media. In one embodiment, the device is a magnetic disc drive that reads from or writes to a removable, nonvolatile magnetic disc. In one embodiment, the device is an optical disc drive that reads from or writes to a removable, nonvolatile optical disc such as a CD ROM or other optical media. Other removable/non-removable, volatile/nonvolatile computer storage media that can be implemented as “the data storage device” include, but are not limited to, magnetic tape cassettes, flash memory cards, digital versatile discs, digital video tape, solid state RAM, solid state ROM, and the like.

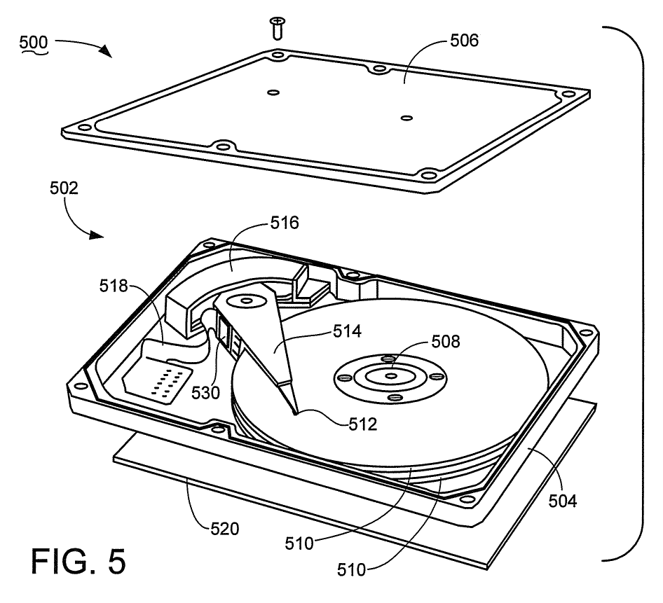

FIG. 5 shows an exploded view of one example of a device that can be implemented in the described schemes and systems as the “data storage device.” In particular, FIG. 5 shows a data storage device 500. The device 500 is illustratively characterized as a hard disc drive of the type used to store and retrieve digital data in a computer system or network, consumer device, etc.

The device 500 includes a rigid, environmentally controlled housing 502 formed from a base deck 504 and a top cover 506. A spindle motor 108 is mounted within the housing 502 to rotate a number of data storage media 510 at a relatively high speed.

Data are arranged on the media 510 in concentric tracks that are accessed by a corresponding array of data transducing heads 512. The heads 512 (transducers) are supported by an actuator 514 and moved across the media surfaces by application of current to a voice coil motor, VCM 516. A flex circuit assembly 518 facilitates communication between the actuator 514 and control circuitry on an externally mounted printed circuit board, PCB 520.

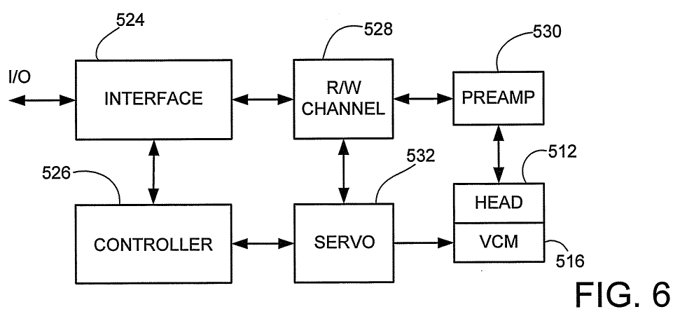

As shown in FIG. 6, the control circuitry preferably includes an interface circuit 524 that communicates with a host device using a suitable interface protocol. A top level processor 526 provides top level control for the device 500 and is preferably characterized as a programmable, general purpose processor with suitable programming to direct the operation of the device 500.

A read/write channel 528 operates in conjunction with a preamplifier/driver circuit (preamp) 530 to write data to and to recover data from the discs 508. The preamp 530 is preferably mounted to the actuator 514 as shown in FIG. 5. A servo circuit 532 provides closed loop positional control for the heads 512.

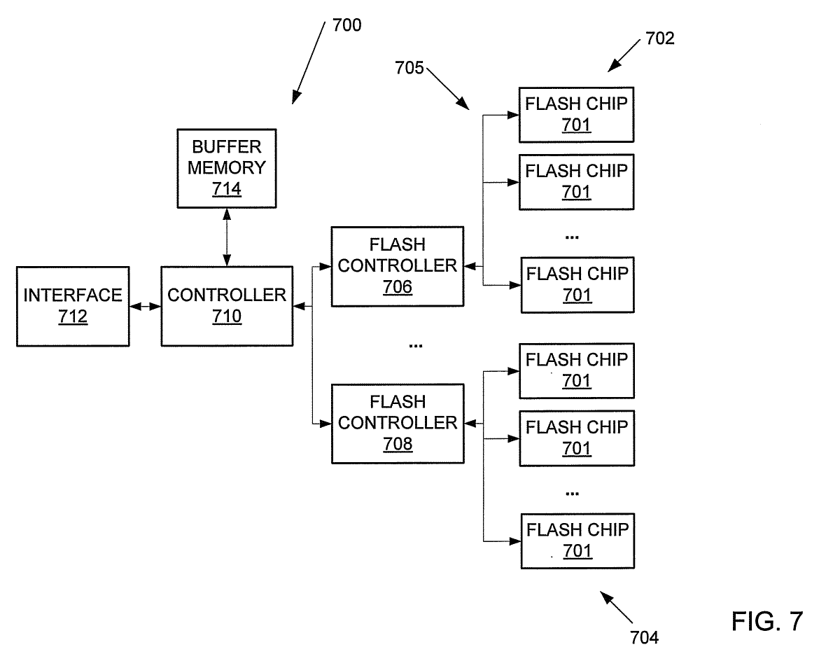

However, it is to be emphasized that the “data storage device” described in the embodiments of schemes and systems of the present invention need not be a disc drive per se. FIG. 7 is a schematic block diagram of an alternate device, namely, a solid state data storage device 700. In contrast with data storage device 500 (of FIG. 5), which employs data storage media that rotate, device 700 has few or no moving parts. As can be seen in FIG. 7, device 700 includes multiple groups of one or more flash memory chips (such as 702 and 704), with each group including a separate flash memory controller 706, 708. In FIG. 7, the flash memory is collectively denoted by reference numeral 705. Storage device 700 also includes a device controller 710 that communicates with individual flash memory controllers (such as 706 and 708). Device controller 710 receives read/write requests via interface 712 and satisfies the requests with the help of the flash memory controllers (such as 706 and 708) and buffer memory 714.

Devices 700 and 100 are but two of many examples of “data storage devices” that are within the scope of the present invention. Those skilled in the art will appreciate that there are certainly other alternatives within the scope of the present invention.

It is to be understood that even though numerous characteristics and advantages of various embodiments of the disclosure have been set forth in the foregoing description, this disclosure is illustrative only, and changes may be made in detail, especially in matters of structure and arrangement of parts within the principles of the disclosure to the full extent indicated by the broad general meaning of the terms in which the appended claims are expressed. In addition, although the embodiments described herein are directed to hard disc drive particle diverters, it will be appreciated by those skilled in the art that the teachings of the disclosure can be applied to other types of data storage systems, without departing from the scope and spirit of the disclosure.

What is claimed is:

1. A data storage device having a maximum storage capacity,
wherein the data storage device is initially limited to providing access to a limited amount of data storage capacity that is less than the maximum data storage capacity, the size of the limited amount of data storage capacity being variable based on an indication of how much of a collection of advertising material has been viewed.

2. The data storage device of claim 1, wherein the size of the limited amount of data storage capacity is variable up to the maximum storage capacity.

3. The data storage device of claim 1, wherein the collection of advertising material is stored on the data storage device.

4. The data storage device of claim 1, wherein the data storage device is a disc drive.

5. The data storage device of claim 1, wherein the data storage device is a solid state data storage device.

6. The data storage device of claim 1, wherein the size of the limited amount of data storage capacity is variable based on an indication of whether additional storage capacity has been purchased.

7. The data storage device of claim 1, wherein the size of the limited amount of data storage capacity is automatically increased when a predetermined portion of the collection of advertising material has been viewed.

8. A data storage system, comprising:
a data storage device having a total data storage capacity that includes an available memory space, an unavailable memory space and a reserved memory space, wherein the available memory space is made available for data storage purposes but the unavailable memory space is not made available for data storage purposes;
a host system that transfers advertising material to the data storage device whereupon it is stored in the reserved memory space; and
wherein data storage capacity is subtracted from the unavailable memory space and added to the available memory space based upon an indication of how much of the advertising material has been consumed.

9. The data storage system of claim 8, wherein data storage space is subtracted from the reserved memory space and added to the available memory spaced based upon the indication of how much of the advertising material has been consumed.

10. The data storage system of claim 8, wherein the amount of data storage capacity subtracted from the unavailable memory space and added to the available memory space is also a function of an indication of whether an extended data storage capacity has been purchased.

11. The data storage system of claim 9, wherein the amount of data storage capacity subtracted from the reserved memory space and added to the available memory space is also a function of an indication of whether an extended data storage capacity has been purchased.

12. The data storage system of claim 8, wherein the data storage device is a disc drive.

13. The data storage system of claim 8, wherein the data storage device is a solid state data storage device.

14. A method for managing a data storage device, the method comprising:
designating a portion of the data storage device as being unavailable for data storage;
receiving an indication that a collection of advertising material has been consumed, wherein the collection of advertising material is stored on the data storage device; and
responding to the indication by making the portion of the data storage device available for data storage.

15. The method of claim 14, wherein the data storage device is a disc drive.

16. The method of claim 14, wherein the data storage device is a solid state data storage device.

17. The method of claim 14, wherein responding further comprises unlocking previously hidden sectors of a disc drive.

19. The method of claim 14, wherein designating a portion further comprises providing one or more hidden sectors of a disc drive.

20. The method of claim 14, wherein the steps are receiving and responding are performed by a host software module, at least a portion of which is at least temporarily stored on the data storage device.
